(19) United States
(12) Patent Application Publication
(10) Pub. No.: US 2004/0136455 A1
(43) Pub. Date: Jul. 15, 2004

(54) Efficient bit stream synchronization

(76) Inventors: Mohammad Shahanshah Akhter, Kanata (CA); Robert Wood, Gloucester (CA); Antonio Mascioli, Nepean (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/694,764

(22) Filed: Oct. 29, 2003

Related U.S. Application Data
(60) Provisional application No. 60/421,808, filed on Oct. 29, 2002.

(51) Int. Cl. H04B 1/66; H04N 11/02; H04N 7/12; H04N 11/04

(52) U.S. Cl. 375/240; 375/240.27; 375/240.24; 375/240.02; 348/384.1; 348/395.1

(57) ABSTRACT

A method of reformatting a data stream comprised of frames arranged into superframes for transmission by a block coding scheme is disclosed herein. The payloads of a plurality of frames are concatenated, where a superframe structure is present the frames in the superframe are concatenated, to form a transmission block. The headers of these frames are replaced by a syncword. The present invention can be used in any communications system which uses MPEG frame form, and can be extended any communications system that can benefit from modification to the frame format. The present invention can be with many demodulator algorithm, an can reduce the complexity of the demodulator

### CROSS REFERENCE TO RELATED APPLICATIONS

This application claims the benefit of priority of U.S. Provisional Patent Application No. 60/421,808 filed Oct. 29, 2002, which is incorporated herein by reference.

### FIELD OF THE INVENTION

The present invention relates generally to the placement of synchronisation bits in a data stream. More particularly, the present invention relates to the use of correlated synchronisation bits to distinguish frames in a turbo encoded MPEG data stream.

### BACKGROUND OF THE INVENTION

Many digital broadcast systems employ standard Motion Picture Expert Group (MPEG) encoding to transmit video signals. In these systems, MPEG frames are broadcast in a continuous data stream from a transmitter. Whereas in a point to point transmission the transmitter can transmit data in advance that allows the receiver to detect the start of an MPEG stream, in a broadcast scenario the receiver is not necessarily initialized at the advent of the MPEG stream, but must be able to begin the decoding in mid-stream. Thus, one of the tasks that an MPEG decoder must perform is a synchronization operation. This synchronization operation allows a decoder to ensure that it knows where the start and end of an MPEG frame are. This operation is partially simplified by the specification of a fixed length MPEG frame, so that only the start of an MPEG frame need be identified, as the next frame will start in a fixed number of bytes.

FIG. 1 illustrates a conventional MPEG frame. According to the MPEG-2 standard, the first byte of the 188 byte MPEG-2 frame 50 is a header 52 having a value of 47_{HEX}. Due to the a priori agreement that frames are 188 bytes in length, and start with a value of 47_{HEX}, a decoder can scan the incoming video stream to synchronize on a series of 47_{HEX} values spaced 188 bytes apart. Thus, a transmitter can broadcast to a plurality of receivers, and the receivers can start decoding the MPEG stream at any point in the transmission, and be guaranteed the ability to synchronize to the start of an MPEG frame.

The MPEG standard also defines a data unit known as a superframe, which is typically 8 frames in length. A superframe is identified by inverting the first MPEG frame header value of 47_{HEX}, herein represented as 47_{HEX}. This provides another synchronisation mechanism.

During the transmission of an MPEG data stream, it is common for the stream to be corrupted due to noise in the transmission channel. Certain channels, such as satellite to ground based receiver channels, are prone to noise and are limited in their channel capacity. The capacity of a channel defines a maximum data rate at which data can be transmitted without error in the presence of noise. At data rates above the defined channel capacity it is impossible to transmit without error. However, at data ratesat or below the defined channel it is possible to transmit without error if sufficient error correcting codes are employed. Due to the desire to transmit an MPEG stream as efficiently as possible in satellite channels, the MPEG stream is typically encoded using an error correcting code.

Turbo codes are known communications codes that provided data encoding with error correcting capability, and offer data rates that approach the maximum channel capacity. To utilise the high data rates achieved by turbo codes relatively large block sizes are used. Thus, in the turbo encoding of an MPEG stream it is common to group a series of MPEG frames together to form a single turbo code source word. The number of MPEG frames grouped together to form a single turbo code source word is a function of the size of the encoder.

FIG. 2 illustrates the concatenation of 5 MPEG frames 50a, 50b and 50c. Each of these MPEG frames includes header 52. The concatenation results in a turbo code source word of 7480 bits in size.

FIG. 3 illustrates a typical system employed in the art to broadcast and MPEG stream. MPEG encoder 56 generates MPEG frames that are concatenated and encoded by turbo encoder 58 using known turbo encoding techniques. The resulting turbo code words are transmitted over channel 60, where they are subject to noise. Upon receipt at turbo decoder 62, the noise corrupted turbo code words are iteratively decoded to recover the turbo code source word illustrated in FIG. 2. The recovered MPEG frames are then provided to the MPEG decoder 64.

To properly decode a turbo code word, turbo decoder 62 must identify the start of a turbo code word. As with the decoding of an MPEG frame, it is essential that the turbo decoder 62 be able to detect the start and end of a turbo codeword. The length of the code word is typically specified a priori, as are such factors as the encoding polynomials, interleaver mappings and puncture masks used in turbo encoder 58. These factors can be used to determine a characteristic parity sequence that is added to the end of the encoded word. This parity sequence may be correlated to the source word, but is usually identifiable to the turbo decoder 62 for the purposes of synchronisation.

As with the MPEG header 52, the synchronisation information introduced by a turbo encoder to allow a decoder to detect the start of a frame in the middle of a broadcast transmission is overhead. The overhead introduced to allow a turbo decoder to detect the start of a turbo code word consumes channel capacity that could otherwise be used for error correction. The existence of the overhead is especially egregious in limited resource channels such as satellite channels that already have overhead associated with the MPEG frame header. Turbo encoding of an MPEG data stream results in overlapping header information, one set of which is used to denote the start of turbo blocks, the other set being used to denote the start of MPEG frames. Simply removing one or the other of the header blocks will result in a data stream that is not recognisable to at least one of the Turbo decoder or the MPEG decoder.

It is, therefore, desirable to provide a transmission system for encoding an MPEG data stream using a turbo encoder that reduces the amount of overhead incurred, while maintaining the decodability of the received stream.

### SUMMARY OF THE INVENTION

It is an object of the present invention to obviate or mitigate at least one disadvantage of previous methods of block coding synchronised data streams.

In a first aspect of the present invention there is provided a method of converting a plurality of MPEG frames, each frame having a header and a payload, into a source word for channel encoding. The method comprises concatenating the payloads of the plurality of MPEG frames; generating a synchronizing word correlated to the concatenated payload; and combining the concatenated payload and the generated synchronizing word to form the source word. In an embodiment of the first aspect of the present invention, the plurality of MPEG frames form an integer multiple number of MPEG superframes and the channel encoding is turbo encoding. In another embodiment, step of generating includes selecting a synchronizing word having a high degree of correlation to the concatenated payload, the synchronizing word being a parity check block computed using either Reed-Solomon encoding or a cyclical redundancy code. In another embodiment, the step of generating includes selecting a synchronizing word in accordance with both the payload and characteristics of the channel encoding, and preferably includes selecting a synchronizing word having the same length as the length of a concatenation of the headers of the plurality of MPEG frames. In a further embodiment, the step of combining includes concatenating the synchronizing word and the concatenated payload, by either interleaving the synchronizing word with the concatenated payload or placing the synchronizing word ahead of the concatenated payload.

In a second aspect of the present invention, there is provided a method of converting a channel encoding source word, having both a payload and a synchronizing word, the synchronizing word used for at least one of channel decoding synchronization and error correction, into a plurality of MPEG frames. The method comprises dividing the source word into the synchronizing word and the payload, payload containing a plurality of MPEG frame payloads; generating an MPEG header; appending one of the plurality of MPEG frame payloads to the generated header; and repeating the steps of generating and appending until each of the plurality of MPEG frame payloads has been appended to a header. In embodiments of the second aspect of the present invention, there is further included a step of correcting errors in the payload of the synchronizing word in accordance with error correction properties of the synchronizing word, wherein the step of correcting preferably includes at least one of performing a cyclical redundancy check in accordance with the synchronizing word and performing a Reed-Solomon decoding in accordance with the synchronizing word. In another embodiment of the present invention, the step of generating the MPEG frame header includes generating a header having a value of 47_{HEX}. In an alternate embodiment, the plurality of MPEG frame payloads form the payload to an integer multiple number of MPEG superframes, and, the step of generating the MPEG header includes generating a header having a value of 47_{HEX} for any MPEG header corresponding to the header of an MPEG superframe.

In a third aspect of the present invention there is provided a source word generator for converting a plurality of MPEG frames, each frame having a header and a payload, into a channel encoding source word. The source word generator comprises a frame formatter, a synchronizing word generator and a combiner. The frame formatter receives the plurality of MPEG frames from an MPEG source, and for concatenates the payloads of each of the plurality of MPEG frames. The synchronizing word generator, generates a synchronizing word in accordance with the concatenated payload. The combiner receives the concatenated payload from the frame formatter, and the synchronizing word from the synchronizing word generator, and combines the concatenated payload and the synchronizing word to form the channel encoding source word. In an embodiment of the third aspect of the present invention, the synchronizing word generator includes at least one of a Reed-Solomon encoder for generating a parity block for use as the synchronizing word and a cyclical redundancy check encoder for generating a parity block for use as the synchronizing word. In another embodiment, the combiner includes means to concatenate the concatenated payload and the synchronizing word to form the channel encoding source word.

In a fourth aspect of the present invention, there is provided an MPEG frame reassembler for converting a channel encoded source word, having both a concatenated payload and a synchronizing word, into a plurality of MPEG frames. The reassembler comprises a synchronizing word identifier, and a header generator. The synchronizing word identifier receives the channel encoded source word and divides the received source word into the synchronizing word and the concatenated payload, the concatenated payload containing a plurality of MPEG frame payloads. The header generator generates headers for MPEG frames and prepends the generated headers to the each of the plurality of MPEG payloads to create a plurality of MPEG frames. In one embodiment of the fourth aspect of the present invention, the reassembler further includes an error corrector for correcting errors in the payload of the source word in accordance with error correction properties of the synchronizing word. In another embodiment, the header generator includes means identifying an MPEG superframe and for generating an MPEG superframe header for prepending to the first MPEG frame in the MPEG superframe. Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a conventional MPEG frame;

FIG. 2 is an illustration of a conventional concatenation of MPEG frames into a turbo code source word;

FIG. 3 is a block diagram of a conventional broadcast system;

FIG. 4 is an illustration of the rearrangement of a conventional superframe into an MPEG source word in the present invention;

FIG. 5 is a block diagram of a system of the present invention; and

FIG. 6 is an illustration of the rearrangement of the MPEG source word of the present invention into a conventional superframe.

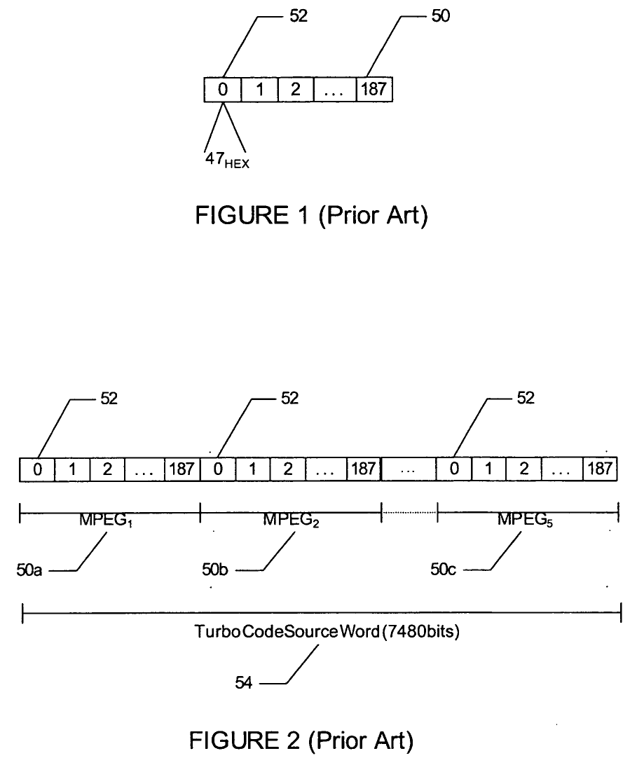

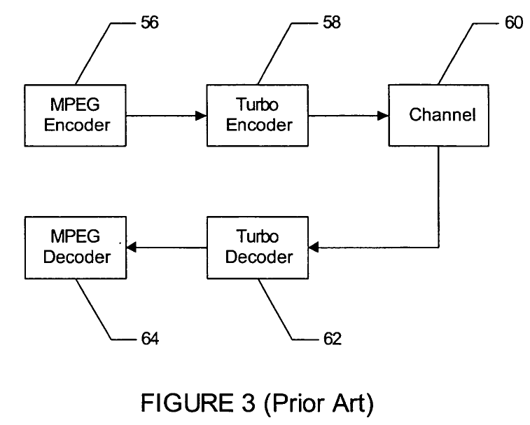

### DETAILED DESCRIPTION

Generally, the present invention provides a method and system for reducing the redundancy of synchronisation in the block encoding of formatted frames.

The present invention relies upon the realisation that the MPEG synchronisation blocks are not required in any of the turbo encoding, transmission and turbo decoding, but must be present for the MPEG decoder to be able to decode the data stream. To avoid the duplication of the overlapping MPEG and turbo synchronisation headers, an embodiment of the present invention effectively aligns the turbo and MPEG encoders so that an MPEG superframe is treated as a single sourceword for the purposes of turbo encoding. Prior to encoding the superframe is rearranged to remove the MPEG specific headers. They are replace with turbo code specific headers. To allow for MPEG decoding at the receiver, the receiver will turbo decode the received signal and substitute the proper headers in the correct locations, which is easily achieved as the headers are deterministic, being either 47_{HEX} or 47_{HEX}, and regularly spaced.

One skilled in the art will appreciate that though the discussion contained herein refers explicitly to turbo codes, the systems and methods of the present invention can be applied to a number of other channel coding methodologies including other convolutional encoding methods, as well as non-convolutional block coding methods.

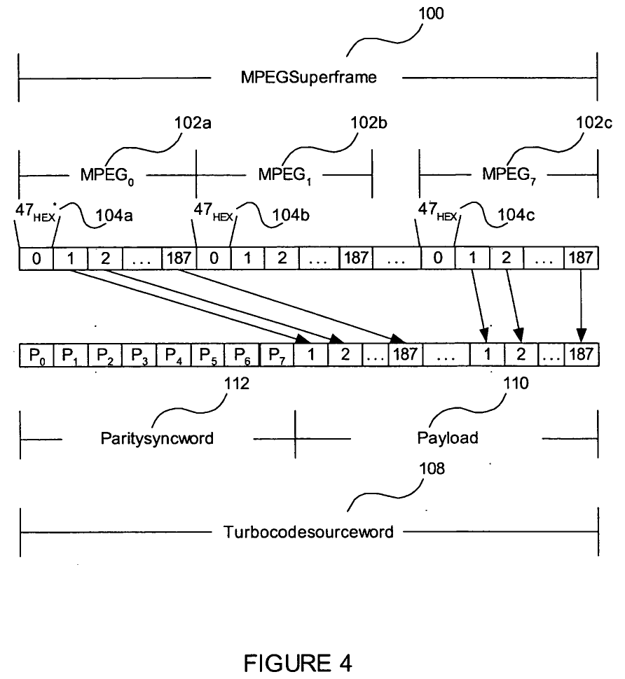

FIG. 4 illustrates the rearrangement of the MPEG stream for the purposes of encoding. MPEG superframe 100 is composed of 8 MPEG frames, MPEG through MPEG₇, 102a, 102b and 102c. Each MPEG frame, 102a, 102b and 102c, has its own respective header 104a, 104b and 104c, which is used for synchronisation. MPEG1 through MPEG7 have headers 104b and 104c of value 47_{HEX}, while MPEG₀ as the start of the superframe has its header inverted to a value of 47_{HEX}. As the MPEG headers 104a-c are purely deterministic, they can be removed prior to turbo encoding so long as they are re-inserted between the turbo decoding and the MPEG decoding. The rearrangement of MPEG superframe and the replacement of its headers results in turbo code source word 108. Turbo code source word 108 is composed of the payload of each MPEG frame concatenated to form payload 110, and a parity sync word 112.

The choice of the sync word 112 allows for the selection of a sync word that can provide additional data correction, and can also be chosen so that it is highly correlated to both the payload and the turbo encoder characteristics. If the sync word 112 is selected so that it has a correlation with the turbo encoder characteristics the amount of overhead required for an external turbo sync word is reduced. In the alternate, sync word 112 can be selected so that it provides additional error correction for the turbo codeword. One skilled in the art will appreciate that though illustrated here as having the same length as the concatenation of the headers of the MPEG superframe 100, the sync word can be of any length.

If the ambition is to introduce additional error detection and correction through the selection of the sync word a CRC-8 checksum can be added. The error detection failure rate at the turbo code packet level of an implementation of such a sync word has been estimated to be 3.9×10⁻³. This failure rate could be reduced below 10⁻³ by using a CRC-16 checksum, at the expense of a very slight decrease in spectral efficiency.

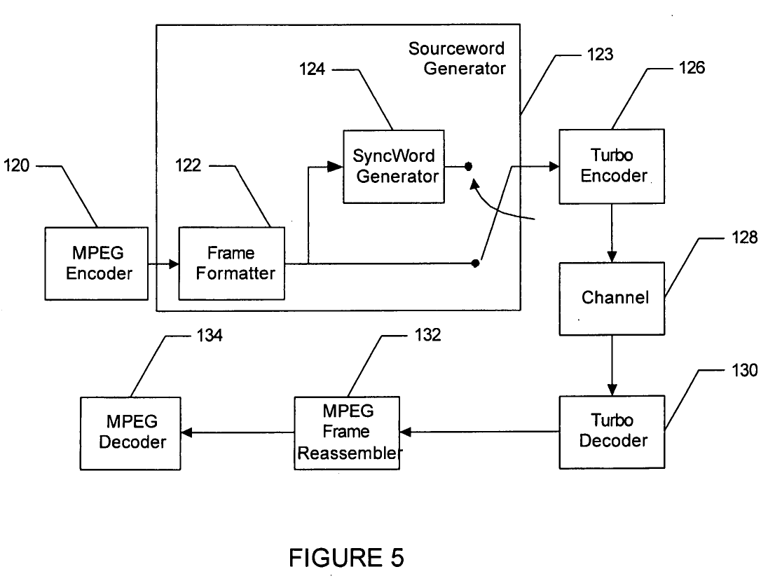

A system for implanting the above described method is illustrated in FIG. 5. MPEG encoder 120 generates a stream of MPEG frames organised into superframes. The superframes are provided source word generator 123, which contains frame formatter 122, sync word generator 124, and a combining mechanism. Inside source word generator 123, the frames are routed to frame formatter 122, which rearranges the frame to concatenate the MPEG payload. The resulting payload is used by sync word generator 124 to determine a sync word that is added to the payload. A combination of the sync word from generator 124 and the payload from frame formatter 122 are provided to turbo encoder 126. One skilled in the art will appreciate that though described above as a single block, sync word 112 can be spread through the payload in a predefined fashion. The turbo code source word 108 is provided to the turbo encoder, which encodes the source word in a conventional fashion, preferably utilising a tail-biting encoding technique. The resultant turbo codeword is transmitted through channel 128 where it is subjected to noise. The noise impacted turbo codeword is received at turbo decoder 130 which utilises an iterative decoding technique to decode the turbo code source word 108. The use of the sync word can contribute to both more rapid convergence in the iterative decoding, and a greater ability to correct the errors introduced by the noise in the channel. The decoded turbo code source word is provided to MPEG frame reassembler 132, where the sync word 112 is removed and the payload is rearranged to form a properly formatted MPEG superframe 100, which is provided to the MPEG decoder 134 for decoding. Frame reassembler 132 preferably includes a sync word identifier to identify the sync word, and allow the non-sync word component of the source word 108 to be disassembled into MPEG frames, and a header generator for generating headers for the MPEG frames and prepending them to the MPEG frame payloads. Optionally, the reassembler 132 can include an error corrector for correcting errors in the MPEG frame payloads using the data in sync word 112.

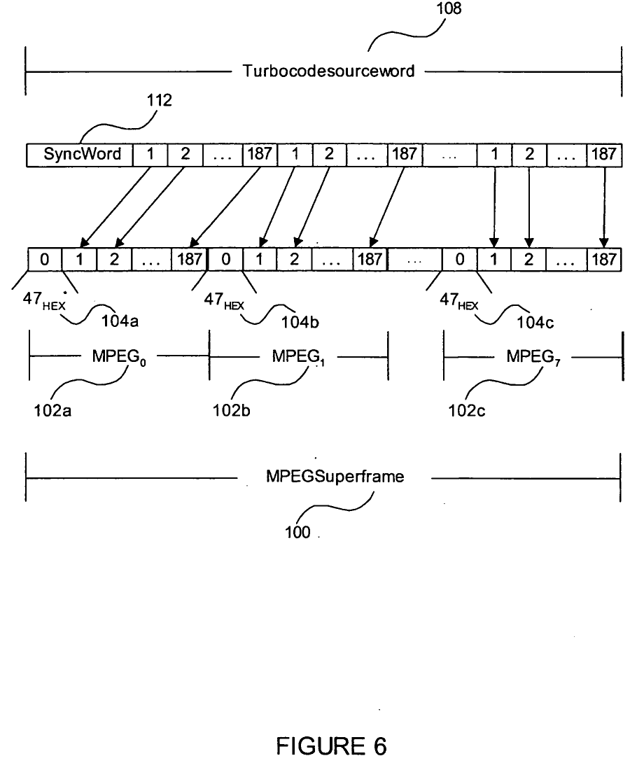

FIG. 6 illustrates the decomposition of turbo code source word 108. Source word 108 is analysed to identify the sync word 112, which is then discarded. The payload is then reassembled, using the a priori knowledge of the arrangement of the data units into a series of MPEG frames, 102a-c, each with a header 104a-c. If the length of the source word 108 corresponds to the length of a superframe, the first MPEG frame, MPEG₀ 102a, is given a header 104a that is inverted to a value of 47_{HEX}. The reassembled MPEG frame is then provided to an MPEG decoder for further processing.

If the syncword 112 is used for the purposes of error correction coding, the decoder must perform frame synchronization without any known sequences present. This typically involves decoding or partially decoding the received data and generating a metric to determine whether the decoded sequence is valid and thus indicating synchronization. This can entail partial decoding of up to N potential turbo codewords, where N is the length of the codeword. Decoding and calculating the corresponding metric needs to be performed across all possible synchronization states. There are two main possible metrics which are available:

Average the log-likelihood ratios (LLRs) generated by the decoder for a full or partial frame, for a single sub-iteration, comparing against a threshold. This method is fast, with the proportion of frame to be decoded dependent on the SNR operating point.

Decode a complete or partial frame's worth of data using a single sub-iteration and re-encode the information bits, comparing the number of bit errors between decoded frame and the re-encoded frame. Preferably the corresponding BER should be close to the expected BER for a single sub-iteration.

To obtain synchronization, a brute force approach can be taken, The number of synchronization states that need to be compared is the product of the frame size in symbols, N (assuming the frame is aligned in symbols), and the number of phase ambiguities, P. As a result, the maximum time to synchronize can be calculated as

Ts=N*P*Td

given Td as the time to decode and compare metrics. If pilot symbols are used and the phase ambiguity is removed, the number of synchronization states is reduced to the frame size in symbols.

Ts=N*Td

In addition, if the pilot symbols are synchronized with the frame duration, the number of synchronization states reduces to the number of pilot symbols present in a complete turbo code frame. Performing a brute force synchronization search on the received sequence requires the decoder to decode and calculate the metric for the interleaved code sequence as the interleaved sequence provides the necessary frame reference. Using the non-interleaved sequence, does not provide the necessary frame reference apart from the frame transition discontinuity.

It is possible to reduce the synchronization time by utilising a multistage approach to the synchronization search. Given that the non-interleaved code sequence can be decoded directly from the received symbols without the need of turbo code frame synchronization, a two stage approach can be used. The first stage, involving decoding the non-interleaved sequence, can be used to resolve the phase ambiguity and puncture period alignment. The number of synchronization states being the product of the phase ambiguities and the symbol puncture period, S.

Ts1=P*S

With the phase and puncture period alignment resolved, the second stage search to determine the turbo code frame alignment has the number of synchronization states reduced accordingly.

Ts2=N/S

To determine the synchronization of the turbo code frame during the second stage, decoding of the interleaved sequence must be performed when calculating metrics. As mentioned, this is because the non-interleaved code does not provide reference to the start of frame apart from the discontinuity at frame boundaries. Although the second stage search uses the interleaved sequence, it is still not necessary to decode the full frame when decoding unless the SNR operating point and metric performance dictate this.

Given an operating turbo-code frame size of 8192 symbols, 8PSK modulation, decoder operating frequency of 220 MHz and the time to decode and test a single synchronization point estimated at 5000 cycles, the maximum time to synchronize is.

Brute Force

Td=1.5 sec

Multiple Stage

Td1=0.36 msec

Td2=0.093 sec

It is possible to further improve the time to synchronize by increasing the number of synchronization states for the first stage, thus decreasing the states for the second stage. One known technique taught in S. S. Pietrobon, “Efficient implementation of continuous MAP decoders and a synchronization technique for turbo decoders,” Int. Symp. on Inform. Theory and its Applic., Victoria, BC, Canada, pp. 586-589, September 1996 adds a known PRBS sequence to the parity bits of the non-interleaved code. The first stage must then search over the duration of this sequence coupled with the phase ambiguities and puncture period:

Td1=P*S*K

Td2=N/S/K

where K is the known PRBS length. By manipulating K, it is possible to optimize such a scheme. However, if the synchronization times of the brute force or standard 2 stage approach are adequate then it is preferred not to have to apply a PRBS sequence to the transmission, complicating the standard unnecessarily.

Using a known synchronizing pattern inserted in the transmitted symbol sequence is a common method of determining frame synchronization. The time required to find a unique word is much less in comparison to the zero-overhead schemes presented above. Adding a unique word to the transmit signal adds overhead, although given the frame size and the required UW length, the UW will only result in a small penalty. For example, if a 40 symbol UW is selected, together with the rate 2/3 8PSK scheme and 16384 bit turbo code frames, the loss due to this extra overhead is only 0.02 dB.

To reduce the number of “errored” MPEG packets received without detection, it is preferable to implement a viable error detection scheme for the DVB-S2 system. With the operating point set at an MPEG PER of 1e-7, the aim is to detect errors with a probability of missing an error targeted at 1e-3. This results in an overall target probability of missing an MPEG packet error of 1e-10. There are two main error detection schemes considered:

Using a Cyclic Redundancy Code (CRC) applied to each MPEG packet to identify errors.

Extending the RS code to perform error detection on a single MPEG packet basis.

Applying a CRC to each MPEG frame is a highly reliable method of determining errored packets. CRCs, when applied to a packet transmission, have particular properties of detecting all single, double and odd number error events across the packet. Treating all error events within the packet equally (i.e. assuming that the packet error distribution is uniform), the asymptotic performance where the probability that a single packet error event will go undetected is 2-(c), where c is the size of the CRC polynomial. Calculatng the performance on a packet error level removes the dependency on the error distribution due to the turbo code or concatenated turbo code+RS. Using the asymptotic performance, the probability of an errored MPEG frame going undetected at the operating point of PER=1e-7, becomes:

Pmiss=1e-7*2-(c)

Table A shows the corresponding performance comparison of different CRC polynomial lengths. The average time between undetected errored packets was calculated given an average information bit rate of 110 Mbit/s. The inclusion of a CRC to the transmission results in a small additional overhead. However, it is possible to replace each MPEG sync word with the CRC codeword, of the same length, for each MPEG frame, thus resulting in zero overhead.

TABLE A
Performance comparison of CRC polynomial lengths

| | CRC-4 | CRC-8 | CRC-12 | CRC-16 | CRC-24 |
|---|---|---|---|---|---|
| Pmiss of CRC scheme | 6.25E−002 | 3.91E−003 | 2.44E−004 | 1.53E−005 | 5.96E−008 |
| Pmiss at operating | 6.25E−009 | 3.91E−010 | 2.44E−011 | 1.53E−012 | 5.96E−015 |
| PER = 1e−7 | | | | | |
| Ave time between | 0.61 | 9.72 | 155.57 | 2489.04 | 637195.27 |
| undetected errored | | | | | |
| packets (in hours) | | | | | |

As mentioned, the asymptotic CRC error performance assumes a uniform packet error distribution. However, this is unlikely, in that although the BER output from the turbo decoder is bursty, it is likely have some non-uniform distribution with increased weighting to the lower number of error events. Given that the CRC has reliable detection for 1,2 and 3 bit error events, the actual Pmiss performance is likely to be slightly better than the asymptotic results presented, with the asymptotic results indicating an upper bound.

Replacing the MPEG sync words with CRC checksums prior to Turbo encoding means that the MPEG sync must be obtained in the receiver after Turbo decoding (so that sync words can be re-inserted). As the block codewords are preferably designed to be the same length as a superframe with its header and the superframe is synchronized to the Turbo code words, this can be achieved easily by having a known relationship between the Turbo code words and the MPEG frames. This can be done by using a Turbo code word length which is an integral number of MPEG frames, or having a low LCM of the Turbo code word length and the MPEG frame length.

For a turbo encoder having two rate 2/3 encoders, a dithered interleaver, where the codewords are provided by a Reed Solomon encoder, a t=2 RS code is desired to achieve performance to 1e-10. It is possible to extend the operation of the same RS code to perform error detection. With such an approach, it is important to synchronize the RS codeword length with the MPEG frame size. This way if an error is detected, only a single MPEG frame is detected to be in error. If the RS codeword length is greater than the MPEG frame size, then two MPEG frames will need to be declared in error, increasing the probability of failure (that an error-free packet be declared in error). By shortening the originally selected RS(255,251) code to RS(192,188) the required MPEG frame alignment can be achieved. This RS code is used to correct up to t=2 error patterns, however if the code is extended to RS(193,188) then t=3 error patterns can be detected, with the addition of a single byte per MPEG frame. If the error distribution of the inner turbo decoder output is such that 4 or more byte errors per MPEG frame is of very low probability, then the above scheme is worthwhile. Given a uniform BER output from the turbo code, the probability of 4 or more byte errors is extremely low (3.4e-24, given a turbo decoder output BER of 2e-9).

Given that both the extended RS and CRC-8 schemes presented result in the same overhead requirements, the CRC-8 is the presently preferred choice for both three stage turbo encoders having RSC encoders with 8, 4 and 8 symbol memories and two stage turbo encoders preceded by RS encoders. CRC-8 will correct all single, double and odd bit error events, which closely matches the performance of the extended t=3 error detecting RS code abilities (assuming a bit error occurrences are equivalent to byte errors).

We can assume that each of the above candidate schemes has similar packet error distribution probabilities at the PER=1e-7 operating point. The only real difference is that the scheme employing an RS encoder will have corrected all single and double byte errors, shifting the packet error distribution slightly. Given this would result in only a marginal shift, it is likely that the CRC error detection will have similar performance.

In a presently preferred embodiment, CRC-8 is applied to each MPEG frame, replacing the sync word which is not required during transmission. The sync word can be replaced after all decoding has been completed. This results in a likely error detection failure rate (Pmiss) of 3.9e-3 without any extra overhead required. Given that a CRC is applied to each and every MPEG frame, the probability of a failure (when an error-free packet is declared in error) will only occur if the CRC byte is in error and the MPEG frame is not. With the CRC codeword only 8 bits long, the probability of failure is low. If the Pmiss of 3.9e-3 is deemed too high, a CRC-12 can be employed which reduces the Pmiss down to 2.4e-4 with the additional 4 bit per MPEG frame overhead.

The present invention can be used in any communications system which uses MPEG frame form, and can be extended any communications system that can benefit from modification to the frame format. The present invention can be used with many demodulator algorithms, and can reduce the complexity of the demodulator if this type of frame structure is used. The present invention allows for an all digital implementation, where complexity varies based on the implementation options is chosen. The present invention allows for the use of a simple correlator to detect the frame boundaries and simple phase ambiguity circuit to resolve phase ambiguity, and can be implemented with an RS decoder or a CRC decoder if error detection is desired in addition to frame synchronization.

One skilled in the art will appreciate that among the advantages of the present invention is that the initial header of a superframe comprised of N frames can be selected such that the overall Turbo code block size can be matched to the size of the superframe. This ensures that different block size encoding is not necessary for different communication links. Additionally, one skilled in the art will appreciate that the method of the present invention will provide the ability to turbo encode and transmit frame format data without extra overhead, and allows synchronization in a continuous communications link environment.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of converting a plurality of MPEG frames, each frame having a header and a payload, into a source word for channel encoding, the method comprising:
concatenating the payloads of the plurality of MPEG frames;
generating a synchronizing word correlated to the concatenated payload; and
combining the concatenated payload and the generated synchronizing word to form the source word.

2. The method of claim 1, wherein the plurality of MPEG frames form an integer multiple number of MPEG superframes.

3. The method of claim 1, wherein the channel encoding is turbo encoding.

4. The method of claim 1, wherein the step of generating includes selecting a synchronizing word having a high degree of correlation to the concatenated payload.

5. The method of claim 4, wherein the step of selecting includes computing a parity check block using Reed-Solomon encoding.

6. The method of claim 4, wherein the step of selecting includes computing a parity check block using a cyclical redundancy code

7. The method of claim 1, wherein the step of generating includes selecting a synchronizing word in accordance with both the payload and characteristics of the channel encoding.

8. The method of claim 1, wherein the step of generating a synchronizing word includes selecting a synchronizing word having the same length as the length of a concatenation of the headers of the plurality of MPEG frames.

9. The method of claim 1, wherein the step of combining includes concatenating the synchronizing word and the concatenated payload.

10. The method of claim 9, wherein the synchronizing word is placed ahead of the concatenated payload.

11. The method of claim 9, wherein the synchronizing word is interleaved with the concatenated payload.

12. A method of converting a channel encoding source word, having both a payload and a synchronizing word, the synchronizing word used for at least one of channel decoding synchronization and error correction, into a plurality of MPEG frames, the method comprising:
dividing the source word into the synchronizing word and the payload, payload containing a plurality of MPEG frame payloads;
generating an MPEG header;
appending one of the plurality of MPEG frame payloads to the generated header; and
repeating the steps of generating and appending until each of the plurality of MPEG frame payloads has been-appended to a header.

13. The method of claim 12, further including the step of correcting errors in the payload of the synchronizing word in accordance with error correction properties of the synchronizing word.

14. The method of claim 13, wherein the step of correcting includes at least one of performing a cyclical redundancy check in accordance with the synchronizing word and performing a Reed-Solomon decoding in accordance with the synchronizing word.

15. The method of claim 12, wherein the step of generating the MPEG frame header includes generating a header having a value of 47_{HEX}.

16. The method of claim 12, wherein the plurality of MPEG frame payloads form the payload to an integer multiple number of MPEG superframes, and, wherein the step of generating the MPEG header includes generating a header having a value of 47_{HEX} for any MPEG header corresponding to the header of an MPEG superframe.

17. A source word generator for converting a plurality of MPEG frames, each frame having a header and a payload, into a channel encoding source word, the generator comprising:
a frame formatter for receiving the plurality of MPEG frames from an MPEG source, and for concatenating the payloads of each of the plurality of MPEG frames;
a synchronizing word generator, for generating a synchronizing word in accordance with the concatenated payload; and
a combiner for receiving the concatenated payload from the frame formatter, and the synchronizing word from the synchronizing word generator, and for combining the concatenated payload and the synchronizing word to form the channel encoding source word.

18. The source word generator of claim 17, wherein the synchronizing word generator includes at least one of a Reed-Solomon encoder for generating a parity block for use as the synchronizing word and a cyclical redundancy check encoder for generating a parity block for use as the synchronizing word.

19. The source word generator of claim 17, wherein the combiner includes means to concatenate the concatenated payload and the synchronizing word to form the channel encoding source word.

20. An MPEG frame reassembler for converting a channel encoded source word, having both a concatenated payload and a synchronizing word, into a plurality of MPEG frames, the reassembler comprising:
a synchronizing word identifier for receiving the channel encoded source word and for dividing the received source word into the synchronizing word and the concatenated payload, the concatenated payload containing a plurality of MPEG frame payloads; and
a header generator for generating headers for MPEG frames and for prepending the generated headers to the each of the plurality of MPEG payloads to create a plurality of MPEG frames.

21. The reassembler of claim 20 further including an error corrector for correcting errors in the payload of the source word in accordance with error correction properties of the synchronizing word.

22. The reassembler of claim 20, wherein the header generator includes means identifying an MPEG superframe and for generating an MPEG superframe header for prepending to the first MPEG frame in the MPEG superframe.
